(19) United States
(12) Patent Application Publication
(10) Pub. No.: US 2005/0041606 A1
(43) Pub. Date: Feb. 24, 2005

(54) Data communication apparatus, data communication method, data communication program and recording medium in which data communication program was recorded

(76) Inventors: Satoshi Hori, Kanagawa (JP); Shinji Ozeki, Gifu (JP); Toru Kitamura, Aichi (JP)

Correspondence Address: MCDERMOTT WILL & EMERY LLP, 600 13th Street, N.W., Washington, DC, 20005-3096, US

(21) Appl. No.: 10/873,644

(22) Filed: Jun. 23, 2004

(30) Foreign Application Priority Data
Dec. 24, 2002 (JP) P. 2002-372812

(51) Int. Cl. H04L 5/22

(52) U.S. Cl. 370/299

(57) ABSTRACT

To carry out data processing with low load and at necessary timing even if a high performance device is not used, and to carry out precise data communication.

A first communication control part 132 converts a plurality of original data to be transmitted, into fixed length data packets by padding, and informs a second communication control part 122 of actual data lengths of these fixed length data packets, by a FIFO memory 146, and also, transmits these fixed length data to the second communication part 122 by DMA, and thereby, a CPU 123 of the second communication control part 122 restores original data from the fixed length data which was transmitted, at short times and with low load, on the basis of actual data lengths.

### BACKGROUND OF THE INVENTION

1. Field of the Invention

This invention relates to a data communication apparatus, a data communication method, a data communication program and a recording medium in which a data communication program was recorded, for supplying or processing, transmitting and receiving data at high speed and continuously, to an external communication line, in particular, a communication line through which data communication has to be carried out at high speed and continuously such as Isochronous communication in USB and IEEE1394, or Bluetoogh and other wireless communication.

2. Description of the Related Art

In a data communication apparatus and a data communication method having first communication means and second communication means which mutually communicate data to be transmitted and received to a conventional external communication line, for example, there was such a thing that the first communication means and the second communication means determine fixed packet length on the basis of maximum packet length which can be communicated continuously all at once, and the first communication means and the second communication means divide message data to be transmitted, into data packets with the determined fixed packet length, to realize Direct Memory Access (DMA) communication (e.g., see, JP-A-2001-101126 publication (Pages 7-8, FIGS. 5-6))

FIG. 7 and FIG. 8 are views which explain the above-described conventional data communication method and a communication apparatus which executes that. The conventional data communication method is a thing which relates, in particular, to a data communication method in an image processing system 901 which is composed of an image input/output part 931 and an image processing part 921. An image reading part 955 is, for example, a scanner, and reads out an image which was printed on a paper, and converts it into digital data with variable length. The variable length digital data is inputted into an image input/output part 931 through an external communication line 957 which is an asynchronous type serial communication line.

Variable length data, which was received by the image input/output part 931 from the external communication line 957, is transmitted from a first communication control part 932 to a second communication control part 922 through a bus 944. Data to be transmitted is an original transmission message 961 as shown in FIG. 8. The first communication control part 932 of the image input/output part 931 divides the original transmission message 961 into data packets 962 with predetermined fixed length. In this example, it is divided into three fixed length data packets.

Packet headers 963, 964 are added to each data packet. The packet header 963 of a packet other than a last packet is 0×01 (which is 2 digits of hexadecimal number, and shows 01. Same below), and the packet header 964 of the last packet is 0×81. The first communication control part 932, which received a data packet by the packet header 964, can know that that data packet is a last one, or there is still continuation.

When the original transmission message 961 was divided into the fixed length data packets 962, it is not necessarily always divisible, and therefore, when it was not divisible, dummy data 065 is padded to the last packet.

The fixed length data packet which was prepared in this manner is handed over from the first communication control part 932 to the communication controller 933 sequentially one by one, and the communication controller 933, every time when it receives one packet, requests a direct memory access controller (hereinafter, simply referred to as “DMAC”) 942 for transmission.

The DMAC 942 receives data of 1 data packet sequentially from the communication controller 933, and stores it in a predetermined area of a RAM 925 through a BUS 944. When it finished storing data of 1 data packet, the DMAC 942 applies an interruption to a CPU 923, and informs the second communication control part 922 of data reception of 1 data packet.

In the second communication control part 922, the CPU 923 reads the data of 1 data packet from the RAM 925, and repeats this to reads out all data packets, and thereafter, restores the original transmission message 961 and hands it over to the image processing part 921.

However, in the such like conventional data communication apparatus or data communication method, every time when 1 data packet is received, an interruption is applied to the CPU 923, and therefore, when the external communication line 957 is of high speed and a time interval for receiving each data packet is short, the interruption processing of the CPU 923 is not made in time, and there is such a case that data reception is failed. In order to avoid the such like failure of data reception, it was necessary to equip high speed and highly functional CPU 923.

Inversely, in such a case that the external communication line 957 is of low speed and time is required to aggregate the original transmission message 961, there is such a case that it was not possible to hand over necessary data to an image generation part 953 at necessary timing. Also, since a data packet includes the dummy data 965 to which padding was applied, it is necessary to inform the second communication control part 922 of actual data length by some sort of method separately, and the second communication control part 922 can not restore the original transmission message 961 unless it received data which shows actual data length, and furthermore, timing of handing over necessary data to the image generation part 953 has been delayed.

### SUMMARY OF THE INVENTION

This invention is a thing which was made in view of the above-described circumstance, and aims to provide a data communication apparatus, a data communication method, a data communication program and a recording medium in which a data communication program was recorded, which can carry out data processing with low load and at necessary timing, even if a high performance device is not used, and which can carry out precise data communication.

In order to solve the above-described problem, an invention which is described in claim 1 is, in a data communication apparatus having first communication means and second communication means which transmit and receive data each other, a data communication apparatus in which a transmitting side of the first communication means or the second communication means is equipped with packet preparation means which prepares one or a plurality of fixed length data packets by carrying out one or both of division or padding data addition to data to be transmitted to communication means of a receiving side, data packet transmission means which transmits the prepared one or a plurality of fixed length data packets to the communication means of the receiving side, and data length transmission means which transmits data length of data other than the padding data, which is included in the prepared one or a plurality of fixed length data packets, to the communication means of the receiving side in accordance with each data packet, and a receiving side of the first communication means and the second communication means is equipped with restoration means which restores original data by deleting the added padding data which is included in the received fixed length data packet with reference to the received data length.

An invention which is described in claim 2 is, in a data communication apparatus having first communication means and second communication means which transmit and receive data each other, a data communication apparatus in which a transmitting side of the first communication means or the second communication means is equipped with packet preparation means which prepares one or a plurality of fixed length data packets by carrying out one or both of division or padding data addition to data to be transmitted to communication means of a receiving side, and data packet transmission means which transmits the prepared one or a plurality of fixed length data packets to the communication means of the receiving side, and a receiving side of the first communication means and the second communication means is equipped with restoration means which restores original data by deleting the added padding data which is included in the received fixed length data packet with reference to the received data length.

According to the inventions which relate to claims 1, 2, by transmitting a plurality of original data to be transmitted, to the communication means of the receiving side as fixed length data packets by padding, and by transmitting actual data lengths of these fixed length data packets, to the communication means of the receiving side, the communication control part of the receiving side can restore the fixed length data which has been transmitted, to original data, with reference to actual data length, at short times and with low load, and therefore, it is possible to carry out data processing with low load and at necessary timing, even if a high performance device is not used, and to carry out precise data communication.

An invention which is described in claim 3 is, in the data communication apparatus which is described in claim 1 or 2, a data communication apparatus in which the data to be transmitted to the communication means of the receiving side is data which was received from an external communication line.

According to the above-described configuration, it is possible to process the received data in accordance with a speed of external communication means.

An invention which is described in claim 4 is, in the data communication apparatus which is described in any one of claims 1 through 3, a data communication apparatus in which, at the transmission side of the first communication means or the second communication means, disposed is transmission means which transmits the restored data to an external communication line.

According to the above-described configuration, even if external communication means is of high speed, it is possible to transmit from the external communication means by carrying out data processing at necessary timing which corresponded to that speed.

An invention which is described in claim 5 is, in the data communication apparatus which is described in any one of claims 1 through 4, a data communication apparatus in which the data packet transmission means transmits the above-described one or a plurality of fixed length data packets to the communication means of the receiving side by direct memory access.

According to the above-described configuration, it is possible to carry out packet (data) transfer in a data transmission apparatus, at high speed without giving a load to a CPU etc., by DMA.

An invention which is described in claim 6 is, in the data communication apparatus which is described in claim 1, a data communication apparatus in which the data length transmission means transmits data length of each data packet to the communication means of the receiving side through a first-in first-out memory.

According to the above-described configuration, it is possible to carry out data transfer at high speed without giving a load to a CPU etc., by transferring original data length in a data transmission apparatus through a FIFO memory.

An invention which is described in claim 7 is, in the data communication apparatus which is described in claim 3, a data communication apparatus in which, when the transmission side of the first communication means or the second communication means did not receive data to be received within a predetermined time, the packet preparation means prepares a fixed length data packet in which all data are composed of padding data.

According to the above-described configuration, even in case that there is no data to be transmitted internally, it is possible to internally transfer a packet in which all are composed of padding data.

An invention which is described in claim 8 is, in a data communication apparatus having first communication means and second communication means which transmit and receive data each other, a data communication method in which a transmission side of the first communication means or the second communication means is equipped with a step of preparing one or a plurality of fixed length data packets by carrying out one or both of division or padding data addition to data to be transmitted to communication means of a receiving side, a step of memorizing the prepared one or a plurality of fixed length data packet, a step of storing data length of data other than the padding data which is included in the memorized one or a plurality of fixed length data packets in a first-in first-out memory with respect to teach data packet, and a step of transmitting the memorized one or a plurality of fixed length data packets to the communication means of the receiving side by direct memory access, and a receiving side of the first communication means and the second communication means is equipped with a step of deleting the added padding data which is included in the received fixed length data packet with reference to the received data length stored in the first-in first-out memory, and a step of transmitting data which is included in a data packet from which the padding data was deleted, to an external communication line.

An invention which is described in claim 9 is a data communication program which has a computer executed each function in such a manner that a transmission side of first transmission means or second communication means is equipped with a function of preparing one or a plurality of fixed length data packets by carrying out one or both of division or padding data addition to data to be transmitted to communication means of a receiving side, a function of memorizing the prepared one or a plurality of fixed length data packet, a function of storing data length of data other than the padding data which is included in the memorized one or a plurality of fixed length data packets in a first-in first-out memory with respect to teach data packet, and a function of requesting transmission of the stored one or a plurality of fixed length data packets, to a direct memory access controller, and a receiving side of the first communication means and the second communication means is equipped with a function of deleting the added padding data which is included in the received fixed length data packet with reference to the received data length stored in the first-in first-out memory, and a function of transmitting data which is included in a data packet from which the padding data was deleted, to an external communication line.

An invention which is described in claim 10 is, in a recording medium in which recorded was a data communication program which is executed by first communication means and second communication means which transmit and receive data each other, a recording medium in which a data communication program was recorded characterized by having a computer readable program for having a computer of a transmission side of the first communication means or the second communication means executed a step of preparing one or a plurality of fixed length data packets by carrying out one or both of division or padding data addition to data to be transmitted to communication means of a receiving side, a step of storing the prepared one or a plurality of fixed length data packet in a predetermined memory area, a step of storing data length of data other than the padding data which is included in the stored one or a plurality of fixed length data packets in a first-in first-out memory with respect to teach data packet, and a step of requesting transmission of the stored one or a plurality of fixed length data packets, to a direct access controller, and for having a computer of a receiving side of the first communication means and the second communication means executed a step of deleting the added padding data which is included in the received fixed length data packet with reference to the received data length stored in the first-in first-out memory, and a step of transmitting data which is included in a data packet from which the padding data was deleted, to an external communication line.

According to the inventions which relate claims 8, 9, 10, by transmitting a plurality of original data to be transmitted, to the communication means of the receiving side as fixed length data packets by padding, and by DMA transmitting actual data lengths of these fixed length data packets, to the communication means of the receiving side, the communication control part of the receiving side can restore the fixed length data which has been transmitted, to original data, with reference to actual data length, at short times and with low load, and therefore, it is possible to carry out data processing with low load and at necessary timing, even if a high performance device is not used, and to carry out precise data communication.

### BRIEF DESCRIPTION OF THE DRAWINGS

FIG. 1 is a block diagram which showed a configuration of a data communication apparatus which relates to a first embodiment of this invention.

FIG. 2 is a view explaining a configuration of a packet which is communicated by the data communication apparatus shown in FIG. 1.

FIG. 3 is a view which shoed a configuration of a fixed length data packet which is used in an embodiment of this invention.

FIG. 4 is a view explaining a configuration of a packet which is communicated by a data communication apparatus which relates to a second embodiment of this invention.

FIG. 5 is a view explaining a configuration of a packet which is communicated by a data communication apparatus which relates to a third embodiment of this invention.

FIG. 6 is a view explaining a configuration of a packet which is communicated by a data communication apparatus which relates to a fourth embodiment of this invention.

FIG. 7 is a view explaining a conventional communication apparatus and a communication method which executes it.

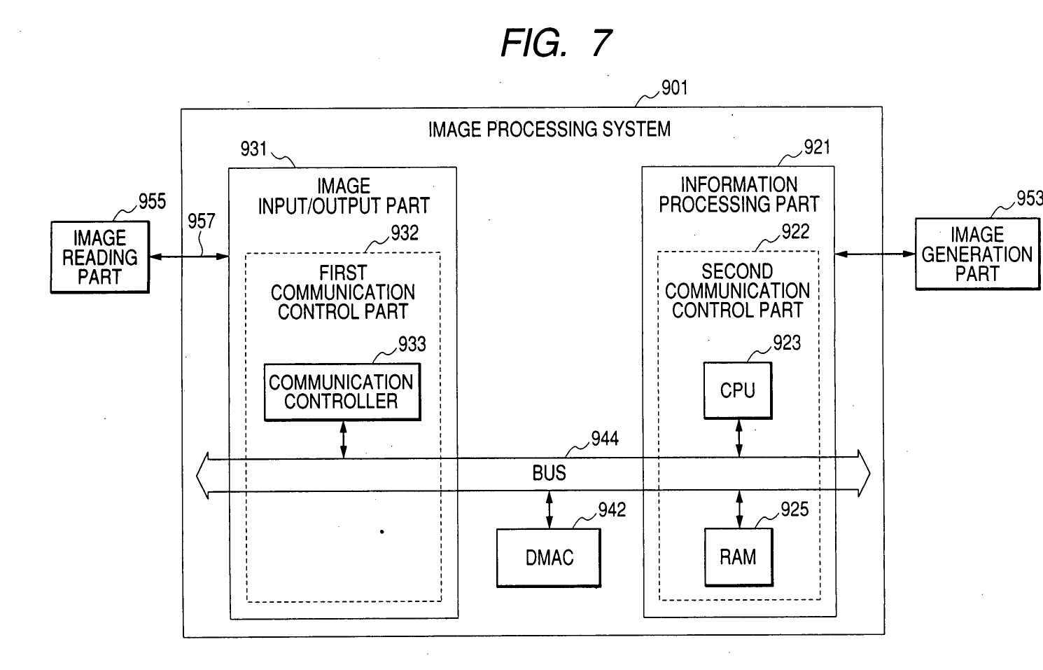

FIG. 8 is a view which showed a configuration example of data which is communicated in the prior art shown in FIG. 7.

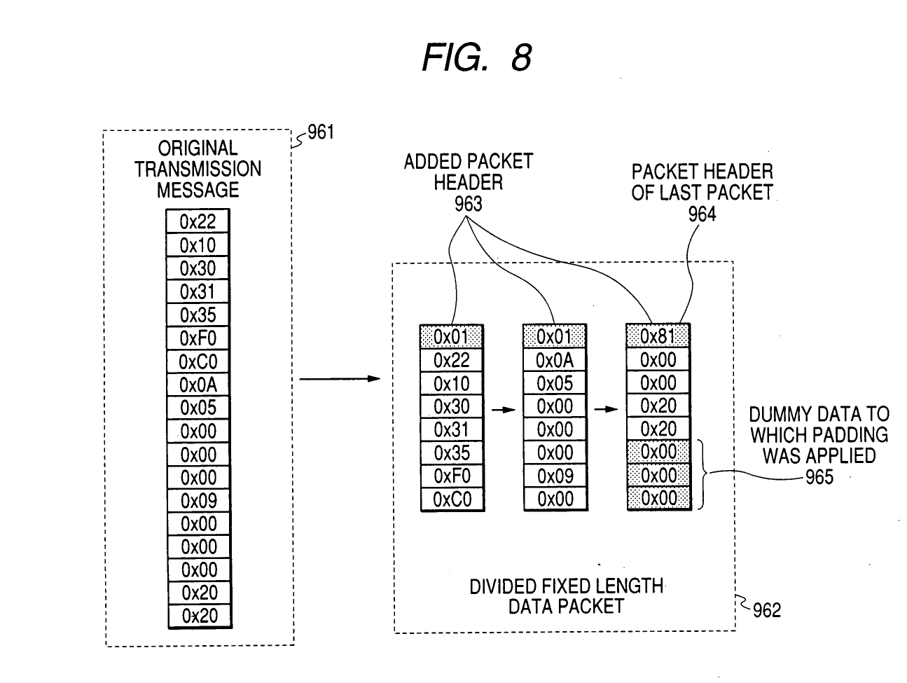

### DESCRIPTION OF THE PREFERRED EMBODIMENTS

Hereinafter, modes for carrying out this invention will be described on the basis of drawings.

(Embodiment 1)

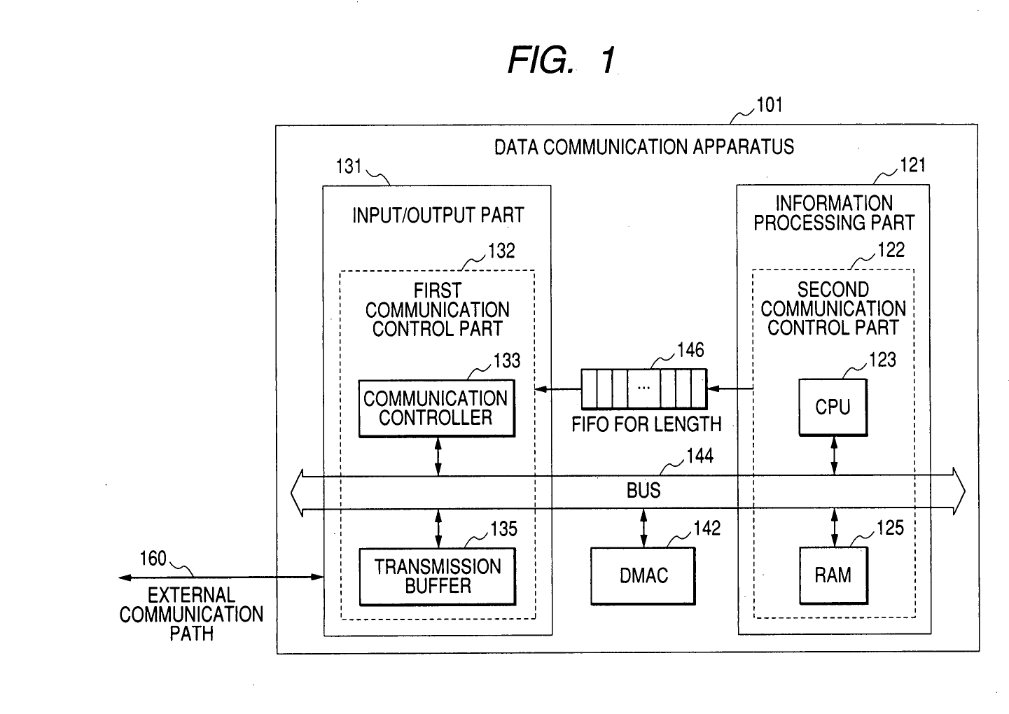

FIG. 1 is a block diagram which showed a configuration of a data communication apparatus which relates to a first embodiment of this invention. A data communication apparatus 101 has, in its inside, an input/output part 131 and an information processing part 121, and furthermore, has a BUS 144 which connects the input/output part 131 and the information processing part 121, a DMAC 142 which was connected to the. BUS 144, and a FIFO (First In First Out) memory 146 which is used for information communication between the input/output part 131 and the information processing part 121. The input/output part 131 is connected to an external communication path 160 which is Isochronous communication etc. of USB or IEEE1394, and carries out data communication with another information equipment or the like, through the external communication path 160. In addition, the external communication path 160 may be, for example, Bluetoogh, other wireless communication and other external communication path 160, other than Isochronous communication etc. of USB or IEEE1394.

The information processing part 121 has, in its inside, a second communication control part 122, and the second communication control part 122 has, in its inside, a CPU 123, a RAM 125, and other various processing parts which are not shown in the figure. In addition, there are such cases that the CPU 123 and the RAM 125 and other processing parts which are not shown in the figure are also used as a portion other than the second communication control part 122 of the information processing part 121, and are not used so.

The input/output part 131 has, in its inside, a first communication part 132, and the first communication part 132 has, in its inside, a communication controller 133 and a transmission buffer 135 and other various processing parts which are not shown in the figure. In addition, there are such cases that the communication controller 133 and the transmission buffer 135 and other various processing parts which are not shown in the figure are also used as a portion other than the first communication control part of the input/output part 131, and are not used so.

Then, an operation of this embodiment will be described. The information processing part 121 and the input/output part 131 are connected by the BUS 144, and transmit and receive data by use of the BUS 144. Data to be transmitted and received is data which was processed by the information processing part 121, and may be data to be outputted from the input/output part 131 to the external communication path 160, and may be data which was inputted by the input/output part 131 from the external communication path 160 and which is to be processed by the information processing part 121, and may be other data.

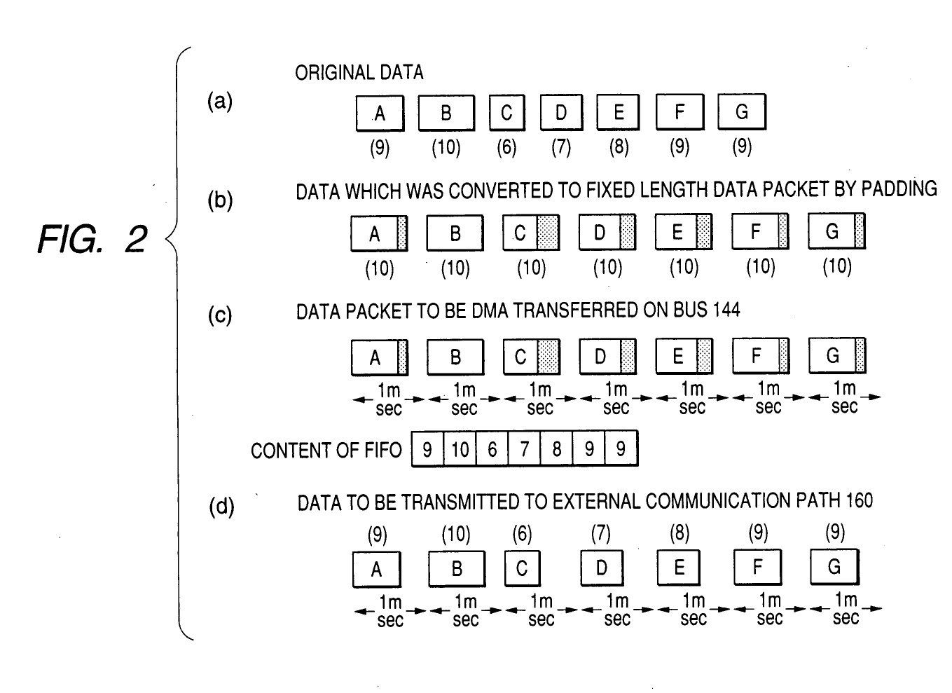

For example, an example of data, which was processed by the information processing part 121 and which is outputted from the input/output part 131 to the external communication path 161, is shown in FIG. 2(a). Original data, which is intended to be outputted, is composed of 7 pieces of variable length data packets A˜G, as shown in FIG. 2(a), and data length of each data packet is 9, 10, 6, 7, 8, 9, 9 bytes, respectively.

When the original data is handed over from the information processing part 121 to the second communication control part 122 in order to be transmitted to the input/output part 131, the CPU 123 of the second communication control part 122 applies padding to variable length data packets, to prepare fixed length data packets.

7 pieces of fixed length data packets, which was prepared by the CPU 123, are shown in FIG. 2(b). By this, the original 7 pieces of variable length data packets A˜G are changed to fixed length data packets A˜G of 10 bytes each.

Then, the CPU 123 stores the 7 pieces of the fixed length data packets of 10 bytes each. Furthermore, the CPU 123 stores actual data length of each fixed length data packet, i.e., length of data other than padding data, in the FIFO memory 146 for length, in the order of A˜G.

In the data example of FIG. 2(a), in the order of “9”, “10”, “6”, “7”, “8”, “9”, “9”, this value is stored in the FIFO memory 146 for length. This content is as shown in FIG. 2(c). The CPU 123 requests the DMAC 142 for transfer of fixed length data on the RAM 125.

The CPU 123, on the occasion of requesting the DMAC 142 for transfer of data, designates an address on the RAM 125 at which data has been stored, the number of overall bytes, and an address on a bus of a communication controller 133 or a transmission buffer 135 of a transfer destination. Data which is transferred on the BUS 144 by the DMAC 142 is as shown in FIG. 2(c).

For example, when there is a vacancy in the transmission buffer 135, there may be such a case that a transmission request is raised from the transmission buffer 135 to the DMAC 142 and data transfer is carried out. Furthermore, by such a fact that data is transmitted from the transmission buffer 135 to the external communication path 160 every 1 ms which is a transmission cycle of the external communication path 160, the transmission buffer 135 falls in a vacant state every 1 ms, and the transmission request is repeated. As a result of that, each data packet is transferred with a unit of, for example, 1 millisecond. However, it is not necessarily limited to this time interval, and it is not absolutely necessary to be an equal time interval.

When the whole thing of data transfer of data packets A˜G is finished, the DMAC 142 applies an interruption to either one or both of the CPU 123 and the communication controller 133, and informs such a fact that the data transfer was completed. Or, in another example, when there is not always necessity for either one or both of the CPU 123 and the communication controller 133 to know the completion of data transfer, or when it is possible to know the completion of data transfer by another method, the interruption may not be carried out. Furthermore, in another embodiment, a request of data transfer from the CPU 123 to the DMAC may be carried out with respect to each one data packet.

It is possible for the CPU 123 to carry out preparation of a next data packet, or to carry out other processing, during such time that the CMAC 142 is transferring data packets. Data which was transferred by the DMAC 142 through the BUS 144 is received by the first communication control part 132.

In the first communication control part 132, the communication controller 133 directly receives that data packet, or stores it once in the transmission buffer 135. When the communication controller 133 directly received that data packet, it may be processed by the communication controller 133 as it is, and may be processed by the communication controller 133 or another processing part which is not shown in the figure, after it was stored once in the transmission buffer 135.

The first communication processing part 132 receives the 7 pieces of fixed length data packets shown in FIG. 2(c), and deletes padding data by referring to a content of the FIFO memory 146 for length, and restores original data. The restoration of original data may be carried out every time that respective fixed length data packets are received, and may be also carried out after all fixed length data packets were received.

The first communication processing part 132 hands over the restored original data to the input/output part 131, and the input/output part 131 outputs that data to the external communication path 160 which is Isochronous communication of USB and IEEE1394.

An example of a data packet is shown in FIG. 2(d). As shown in FIG. 2(d), in this example, it is outputted to the external communication path 160 such as USB, with a unit of 1 millisecond. However, it is not necessarily limited to this time interval, and it is not absolutely necessary to be an equal time interval.

In this embodiment, actual data length, i.e., length of data other than padding data was stored in the FIFO memory 146 for length, in the order of A˜G, and it was informed to the first communication control part 132, but in another embodiment, it is also possible to add actual data length to a fixed length data packet, and to transfer it to the first communication control part 132 by the DMAC 142 by use of the BUS 144.

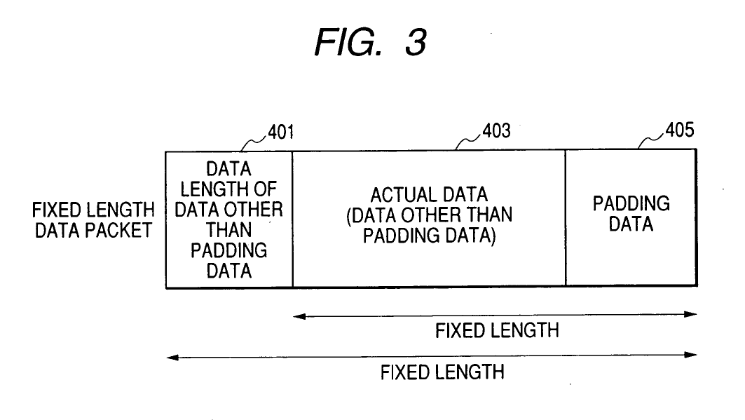

A configuration of the fixed length data packet in this embodiment is shown in FIG. 3. The fixed length data packet is prepared by such a fact that padding data 405 is padded to data 403 other than the padding data, and furthermore, data length 401 of the data other than the padding data is added to it, and the fixed length data packet, which is transferred on the BUS 144, is prepared.

In this embodiment, the first communication control part 132, which received the 7 pieces of fixed length data packets to which the data length 401 of data other than padding data was added, deletes the padding data 405 by referring to the data length 401 of data other than padding data which is included in the received data packet, but not by referring to a content of the FIFO memory 146 for length, and restores original actual data 403.

According to this embodiment, the CPU 123 of the information processing part 121 changes a plurality of original data to be transmitted, to fixed length data packets, by padding, and informs the first communication control part 132 of actual data lengths of these fixed length data packets by the FIFO memory 146, and also, transmits these fixed length data to the first communication part 132 by the DMA, and therefore, the communication controller 133 of the first communication control part 132 restores original data from fixed length data which has been transmitted, at short times and with low load, on the basis of length of actual data, and transmits the restored data from the input/output part 131 onto the external communication path 160, and therefore, it is possible to carry out sufficiently fast and precise data processing, even if so high performance one as the CPU 123 and the communication controller 133 is not used.

(Embodiment 2)

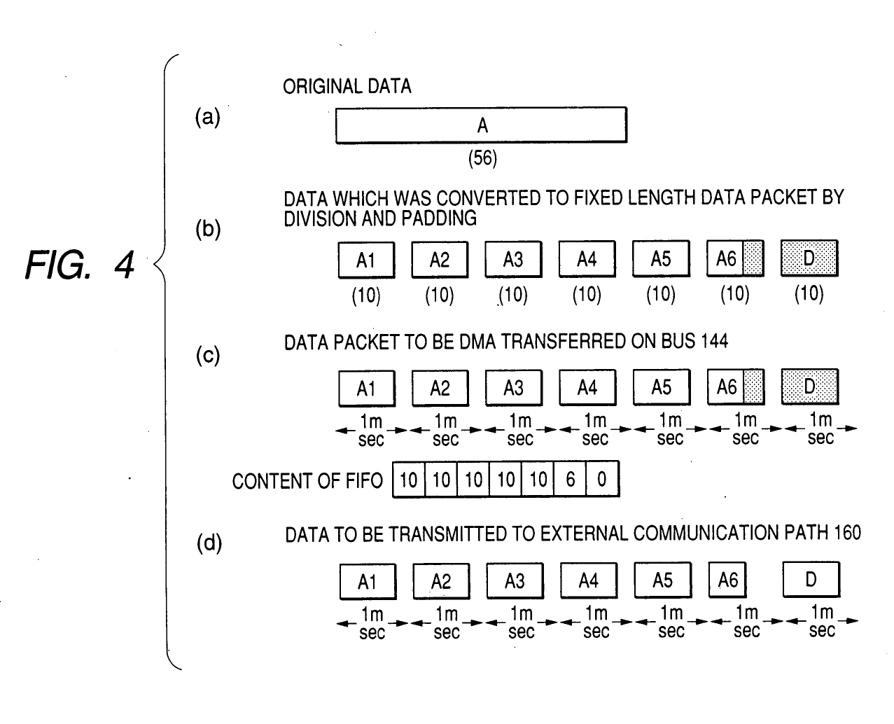

FIG. 4 is a view explaining a configuration of a packet to be communicated by a data communication apparatus which relates to a second embodiment of this invention. In addition, since a configuration of the second embodiment is the same as that of the first embodiment, hereinafter, as to each part having the same configuration, explanations of its configuration and operations will be omitted, and herein after, only its different point will be described.

An example of data which was processed by the information processing part 121 which is the second embodiment, and which is outputted from the input/output part 131 to the external communication path 160 is shown in FIG. 4(a).

Original data which is intended to be outputted, as shown in FIG. 4(a), is composed of 1 piece of a variable length data packet A, and in this embodiment, data length of the data packet A is 56 bytes.

When original data is handed over from the information processing part 121 to the second communication control part 122 in order to be transmitted to the input/output part 131, the CPU 123 of the second communication control part 122 divides the variable length data packet into 5 pieces (A1˜A5) of fixed length data blocks which is composed of 10 bytes each, and applies 4 byte-padding to a sixth block A6, to prepare a fixed length data block A6 which is composed of 10 bytes. Furthermore, if need arises, it prepares a fixed length dummy packet D which is composed of 10 bytes just the same.

The dummy packet D is not absolutely necessary, and according to another embodiment, there is such a case that 2 or more dummy packets become necessary. For example, 7 pieces of fixed length data packets; which were prepared by the CPU 123, is shown in FIG. 4(b). By this, the original 1 piece of variable length data packet A is changed to 7 pieces of fixed length data packets A1˜A6 and D of 10 bytes each.

Then, the CPU 123 stores the 7 pieces of fixed length data packets of 10 bytes each, in the RAM 125. Furthermore, the CPU 123 stores actual data length of each fixed length data packet, i.e., length of data other than padding data, in the FIFO memory 146 for length, in the order of A1˜D.

In the example shown in FIG. 4(b), in the order of “10”, “10”, “10”, “10”, “10”, “6”, “0”, this value is stored in the FIFO memory 146 for length. This content is as shown in FIG. 4(c). The CPU 123 requests the DMAC 142 for transfer of fixed length data on the RAM 125.

Data, which is transferred on the BUS 144 by the DMAC 142, is shown in FIG. 4(c). For example, when there is a vacancy in the transmission buffer 135, there may be such a case that a transmission request is raised from the transmission buffer 135 to the DMAC 142 and data transfer is carried out. Furthermore, by such a fact that data is transmitted from the transmission buffer 135 to the external communication path 160 every 1 ms which is a transmission cycle of the external communication path 160, the transmission buffer 135 falls in a vacant state every 1 ms, and the transmission request is repeated.

As a result of that, each data packet is transferred with a unit of, for example, 1 millisecond. However, it is not necessarily limited to this time interval, and it is not absolutely necessary to be an equal time interval. The data, which was transferred by the DMAC 142 through the use of the BUS 144, is received by the first communication control part 132.

The first communication processing part 132 receives the 7 pieces of fixed length data packets shown in FIG. 4(c), and deletes padding data by referring to a content of the FIFO memory 146 for length, and restores original data. The first communication part 132 hands over the restored original data to the input/output part 131, and the input/output part 131 outputs that data to the external communication path 160 which is Isochronous communication etc. of USB or IEEE1394.

An example of that data packet is shown in FIG. 4(d). As shown in FIG. 4(d), in this example, it is outputted to the external communication path 160 such as USB, including the dummy packet D, with a unit of 1 millisecond.

However, in another embodiment, it is not always necessary that it is outputted with a unit of 1 millisecond, as in this embodiment, and it is not absolutely necessary to be outputted at equal time interval. In another embodiment, for example, it may be outputted at higher speed, or at slower speed or continuously. Also, furthermore, in another embodiment, it is not absolutely necessary to be outputted including the dummy packet D, and the dummy packet D may be deleted by the first communication part 132 or the input/output part 131, and may not be outputted to the external communication path 160.

In this embodiment, actual data length, i.e., length of data other than padding data was stored in the FIFO memory 146 for length, and it was informed to the first communication control part 132, but in another embodiment, it is also possible to add actual data length to a fixed length data packet, to make a fixed length data packet as shown in for example, FIG. 3, and to transfer it to the first communication control part 132 by the DMAC 142 through use of the BUS 144, which is the same as in the first embodiment.

According to this embodiment, since the information processing part 121 converts 1 piece of original data A to be transmitted, into a plurality of fixed length data packets by padding, and thereafter, carries out the same processing as in the first embodiment, there is the same advantage as in the first embodiment.

(Embodiment 3)

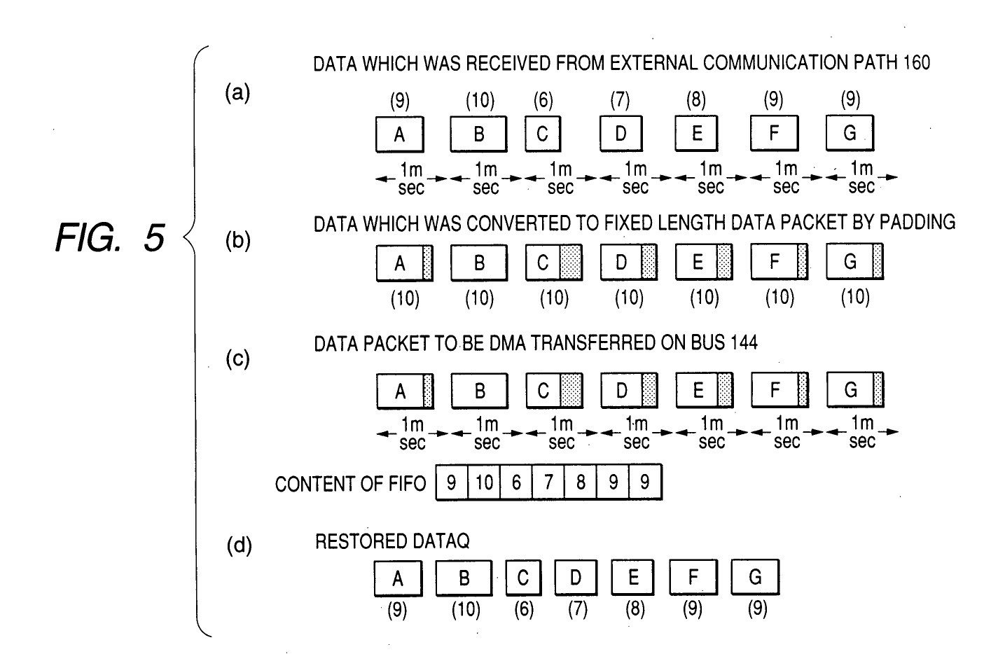

FIG. 5 is a view explaining a configuration of a packet to be communicated by a data communication apparatus which relates to a third embodiment of this invention. In addition, since a configuration of the third embodiment is the same as that of the first embodiment, hereinafter, as to each part having the same configuration, explanations of its configuration and operations will be omitted, and hereinafter, only its different point will be described.

In the third embodiment, an example of data, which was inputted by the input/output part 131 from the external communication path 160, and which is inputted to and outputted from the data communication apparatus 101, is shown in FIG. 5.

The input/output part 131 receives sequentially variable length data packets as shown in, for example, FIG. 5(a), from the external communication path 160. The input/output part 131, in order to transmit the received data to the information processing part 121, hands it over to the first communication control part 132. The communication controller 133 of the first communication control part 132 applies padding to variable length data packets, and prepares fixed length data packets of 10 bytes each. One example of a fixed length data packet, which was prepared by the communication controller 133, is shown in FIG. 5(b).

Then, the communication controller 133 stored the fixed length data packets of 10 bytes each, for example, in the transmission buffer 135. Furthermore, the communication controller 133 stores actual data length of each fixed length data packet, i.e., length of data other than padding data, in the received order, in the FIFO memory 146 for length.

The communication controller 133 requests the DMAC 142 for transfer of fixed length data packets on the transmission buffer 135. There is also such a case that the CPU 123 designates, an address on the transmission buffer 135 at which data has been stored, the number of overall bytes, an address of the RAM 125 of a transfer destination, in advance to the DMAC 142.

One example of data, which is transferred on the BUS 144 by the DMAC 142, is shown in FIG. 5(c). Data, which was transferred by the DMAC 142 through the use of the BUS 144, is received by the second communication control part 122. In the second communication control part 122, for example, the fixed length data packets are once stored in the RAM 125.

In the second communication control part 122, the CPU 123 pulls out the 7 pieces of fixed length data packets show in FIG. 5(c), from the RAM 125, and deletes padding data by referring to a content of the FIFO memory 146 for length, and restores original data. The restoration of original data may be carried out every time that respective fixed length data packets are received, and may be also carried out after all fixed length data packets were received. The second communication control part 122 hands over the restored original data to the information processing part 121, and the information processing part 121 carries out necessary information processing by use of that data.

In this embodiment, actual data length, i.e., length of data other than padding data was stored in the FIFO memory 146 for length, and it was informed to the second communication control part 122, but in another embodiment, it is also possible to add actual data length to a fixed length data packet, to make a fixed length data packet as shown in for example, FIG. 3, and to transfer it to the first communication control part 132 by the DMAC 142 through use of the BUS 144. Since this point is also the same as in the first embodiment, explanations will be omitted.

According to this embodiment, the first communication part 132 converts a plurality of original data, which was inputted from the external communication path 160, into fixed length data packets, by padding, and informs the second communication control part 122 of actual data lengths of these fixed length data packets by the FIFO memory 146, and also transmits these fixed length data to the second communication part 121 by the DMA, and thereby, the CPU 123 of the second communication control part 122 restores the fixed length data, which was transmitted, to original data at short times and with low load, on the basis of actual data length, and carries out necessary processing by use of the restored data, and therefore, it is possible to carry out precise data processing which corresponded to a speed of the external communication path 160, even if the external communication path 160 is of low speed, or of high speed, and so high performance one as the communication controller 133 is not used, and also, it is possible to carry out sufficiently fast and precise data processing, even if so high performance one as the CPU 123 is not used.

(Embodiment 4)

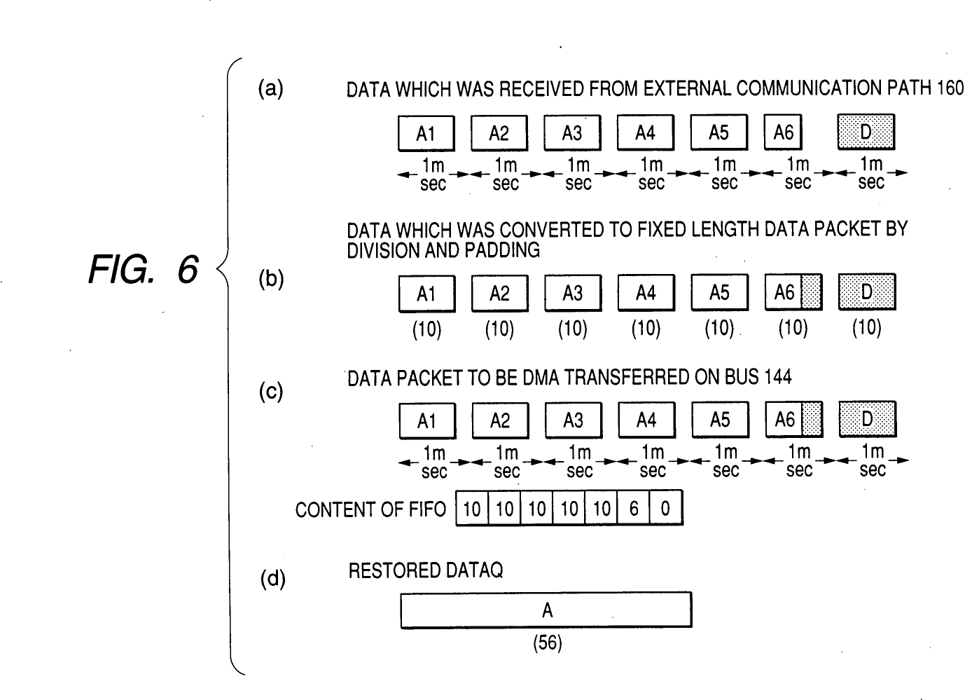

FIG. 6 is a view explaining a configuration of a packet to be communicated by a data communication apparatus which relates to a fourth embodiment of this invention. In addition, since a configuration of the fourth embodiment is the same as that of the first embodiment, hereinafter, as to each part having the same configuration, explanations of its configuration and operations will be omitted, and herein after, only its different point will be described.

In the fourth embodiment, an example of data, which was inputted by the input/output part 131 from the external communication path 160, and which is inputted to and outputted from the data communication apparatus 101, is shown in FIG. 6.

In case that the input/output part 131 received each variable length data packet shown in FIG. 6(a) with a predetermined period of time, for example, within 1 ms, the same operation as in the third embodiment will be carried out.

When the input/output part 131 received, as a data packet, the dummy packet D shown in, for example, FIG. 6(a), from the communication path 160, within for example, 1 ms, the received data is a fixed length data packet of for example, 10 bytes, in which all data is composed of padding data.

The communication controller 133 of the first communication control part 132 prepares, for example, D packet shown in FIG. 6(b), and stores it in the transmission buffer 135, and also, stores a value zero (0) as actual data length, i.e., data length of data other than padding data, in the FIFO memory 146 for length. Furthermore, if need arises, also at the time when a data packet was not received within 1 ms, it prepares, for example, the D packet shown in FIG. 6(b),a fixed length data packet of 10 bytes in which all data is composed of padding data, and stores it in the transmission buffer 135, and stores a value zero (0) as actual data length, i.e., data length of data other than padding data in the FIFO memory 146 for length.

A fixed length data packet to which padding was applied is shown in FIG. 6(b), and contents of a data packet to be transferred on the BUS 144 and the FIFO memory are shown in FIG. 6(c). One example of a data packet, which is restored by the second communication control part 122 which received the data packet, is shown in FIG. 6(d). However, it is not absolutely necessary that the such like data packet is restored, and it may be restored to a data packet of another form.

The data, which was restored as described above, is transferred to the information processing part 121 on the BUS 144 by the DMAC 142. Since operations of the information processing part 121 after that are the same as those of the third embodiment, explanations will be omitted.

According to this embodiment, in case that the input/output part 131 could not receive a data packet within a time frame, from the external communication path 160, prepared is, for example, a fixed length data packet of 10 bytes in which all data is composed of padding data, and these fixed length data packets are transferred to the information processing part 121, but its operation is the same as that of the third embodiment, and there is the same advantage.

According to this invention, a plurality of original data to be transmitted are transmitted to communication means of a receiving side, as fixed length data packets, by padding, and actual data lengths of these fixed length data packets are transmitted to the communication means of the receiving side, and thereby, the communication means of the receiving side can restore original data at short times and with low load, by referring to actual data length of fixed length data which was transmitted, and therefore, it is possible to carry out data processing with low load and at necessary timing even if a high performance device is not used, and to carry out precise data communication.

1. A data communication apparatus having first communication means and second communication means which transmit and receive data each other, wherein:
a transmitting side of the first communication means or the second communication means is equipped with:
packet preparation means, which prepares one or a plurality of fixed length data packets by carrying out one or both of division or padding data addition to data to be transmitted to communication means of a receiving side;
data packet transmission means, which transmits the prepared one or a plurality of fixed length data packets to the communication means of the receiving side; and
data length transmission means, which transmits data length of data other than the padding data, which is included in the prepared one or a plurality of fixed length data packets, to the communication means of the receiving side in accordance with each data packet; and
a receiving side of the first communication means and the second communication means is equipped with:
restoration means which restores original data by deleting the added padding data which is included in the received fixed length data packet with reference to the received data length.

2. A data communication apparatus having first communication means and second communication means which transmit and receive data each other, wherein:
a transmitting side of the first communication means or the second communication means is equipped with:
packet preparation means, which prepares one or a plurality of fixed length data packets by carrying out one or both of division or padding data addition to data to be transmitted to communication means of a receiving side; and
data packet transmission means, which transmits the prepared one or a plurality of fixed length data packets to the communication means of the receiving side; and
a receiving side of the first communication means and the second communication means is equipped with:
restoration means which restores original data by deleting the added padding data which is included in the received fixed length data packet with reference to the received data length.

3. The data communication apparatus according to claim 1, wherein the data to be transmitted to the communication means of the receiving side is data which was received from an external communication line.

4. The data communication apparatus according to claim 1, wherein at the transmission side of the first communication means or the second communication means, disposed is transmission means which transmits the restored data to an external communication line.

5. The data communication apparatus according to claim 1, wherein the data packet transmission means transmits the one or a plurality of fixed length data packets to the communication means of the receiving side by direct memory access.

6. The data communication apparatus according to claim 1, wherein the data length transmission means transmits data length of each data packet to the communication means of the receiving side through a first-in first-out memory.

7. The data communication apparatus according to claim 3, wherein when the transmission side of the first communication means or the second communication means did not receive data to be received within a predetermined time, the packet preparation means prepares a fixed length data packet in which all data are composed of padding data.

8. A data communication method having first communication means and second communication means which transmit and receive data each other, wherein:
the second communication means is equipped with:
a step of preparing one or a plurality of fixed length data packets by carrying out one or both of division or padding data addition to data to be transmitted to communication means of a receiving side;
a step of memorizing the prepared one or a plurality of fixed length data packet;
a step of storing data length of data other than the padding data which is included in the memorized one or a plurality of fixed length data packets in a first-in first-out memory with respect to teach data packet; and
a step of transmitting the memorized one or a plurality of fixed length data packets to the communication means of the receiving side by direct memory access; and
a receiving side of the first communication means and the second communication means is equipped with:
a step of deleting the added padding data which is included in the received fixed length data packet with reference to the received data length stored in the first-in first-out memory; and
a step of transmitting data which is included in a data packet from which the padding data was deleted, to an external communication line.

9. A data communication program characterized by having a computer executed each function in such a manner that
a transmission side of first transmission means or second communication means is equipped with:
a function of preparing one or a plurality of fixed length data packets by carrying out one or both of division or padding data addition to data to be transmitted to communication means of a receiving side,
a function of memorizing the prepared one or a plurality of fixed length data packet,
a function of storing data length of data other than the padding data which is included in the memorized one or a plurality of fixed length data packets in a first-in first-out memory with respect to teach data packet, and
a function of requesting transmission of the stored one or a plurality of fixed length data packets, to a direct memory access controller, and
a receiving side of the first communication means and the second communication means is equipped with a function of deleting the added padding data which is included in the received fixed length data packet with reference to the received data length stored in the first-in first-out memory, and
a function of transmitting data which is included in a data packet from which the padding data was deleted, to an external communication line.

10. A recording medium in which recorded was a data communication program which is executed by first communication means and second communication means which transmit and receive data each other,
a recording medium in which a data communication program was recorded characterized by having a computer readable program for having
a computer of a transmission side of the first communication means or the second communication means executed
a step of preparing one or a plurality of fixed length data packets by carrying out one or both of division or padding data addition to data to be transmitted to communication means of a receiving side,
a step of storing the prepared one or a plurality of fixed length data packet in a predetermined memory area,
a step of storing data length of data other than the padding data which is included in the stored one or a plurality of fixed length data packets in a first-in first-out memory with respect to teach data packet, and
a step of requesting transmission of the stored one or a plurality of fixed length data packets, to a direct access controller, and
for having a computer of a receiving side of the first communication means and the second communication means executed a step of deleting the added padding data which is included in the received fixed length data packet with reference to the received data length stored in the first-in first-out memory, and
a step of transmitting data which is included in a data packet from which the padding data was deleted, to an external communication line.
